(19) United States
(12) Patent Application Publication
(10) Pub. No.: US 2007/0206022 A1
(43) Pub. Date: Sep. 6, 2007

(54) Method and apparatus for associating text with animated graphics

(75) Inventor: Christopher Michael Skaggs, Newberg, OR (US)

Correspondence Address: SCHWABE, WILLIAMSON & WYATT, P.C.;PACWEST CENTER, SUITE 1900, 1211 SW FIFTH AVENUE, PORTLAND, OR, 97204, US

(73) Assignee: The Oakmont Group, Inc.

(21) Appl. No.: 11/369,450

(22) Filed: Mar. 6, 2006

(51) Int. Cl. G09G 5/00

(52) U.S. Cl. 345/581

(57) ABSTRACT

Embodiments of methods, apparatuses, and/or systems for creating a file to associate text with animated graphics are generally described herein. Other embodiments may be described and claimed.

### FIELD

Disclosed embodiments of the present invention relate generally to the field of animated graphics, and more particular to association of text with animated graphics.

### BACKGROUND

Animated graphics allow for the presentation of dynamic content to a viewer of a webpage. While many viewers find the animations visually appealing, animated graphics present a host of challenges when it comes to organizing, interpreting and/or indexing the content displayed.

### BRIEF DESCRIPTION OF THE DRAWINGS

Embodiments of the invention are illustrated by way of example and not by way of limitation in the figures of the accompanying drawings, in which like references indicate similar elements and in which:

FIG. 1 illustrates some aspects of associating text with animated graphics, in accordance with various embodiments of this invention;

FIG. 2 illustrates digital devices to provide for viewing agent to render a document, in accordance with various embodiments of this invention;

FIG. 3 illustrates some aspects of indexing a document, in accordance with various embodiments of this invention;

FIG. 4 illustrates some aspects of an animated graphics-to-text conversion method, in accordance with various embodiments of this invention;

FIG. 5 illustrates a user interface of authoring application, in accordance with various embodiments of this invention; and

FIG. 6 illustrates an example computer system suitable for use for authoring application, in accordance with various embodiments of this invention.

### DETAILED DESCRIPTION

Embodiments of the present invention include, but are not limited to, a method for associating text with animated graphics. In particular embodiments of the present invention provide for creating a file for rendering of a document having animated graphics displayed in a manner to obfuscate a simultaneously rendered text component in a viewing environment. Other embodiments of the present invention may include, but are not limited to, apparatuses and systems adapted to facilitate practice of the above-described method.

In the following description, various aspects of embodiments of the present invention will be described. However, it will be apparent to those skilled in the art that other embodiments may be practiced with only some or all of the described aspects. For purposes of explanation, specific numbers, materials and configurations are set forth in order to provide a thorough understanding of the embodiments. However, it will be apparent to one skilled in the art that other embodiments may be practiced without the specific details. In other instances, well-known features are omitted or simplified in order not to obscure the description.

Parts of the descriptions of various embodiments will be presented in terms of operations performed by a processor-based device, using terms such as data and the like, consistent with the manner commonly employed by those skilled in the art to convey the substance of their work to others skilled in the art. As well understood by those skilled in the art, the quantities may take the form of electrical, magnetic, or optical signals capable of being stored, transferred, combined, and otherwise manipulated through mechanical and electrical components of the processor-based device; and the term processor includes microprocessors, micro-controllers, digital signal processors, and the like, that are stand-alone, adjunct or embedded.

Various operations will be described as multiple discrete operations in turn, in a manner that is most helpful in understanding the embodiments; however, the order of description should not be construed as to imply that these operations are necessarily order dependent. In particular, these operations need not be performed in the order of presentation.

The phrase “in some embodiments” is used repeatedly. The phrase does not generally refer to the same group of embodiments, however, it may. The phrase “in various embodiments” is used repeatedly. The phrase does not generally refer to the same group of embodiments, however, it may. The terms “comprising,” “having” and “including” are synonymous, unless the context dictates otherwise.

In providing some clarifying context to language which may be used in connection with various embodiments, the phrase “A/B” means “A or B.” The phrase “A and/or B” means “(A), (B), or (A and B).” The phrase “at least one of A, B and C” means “(A), (B), (C), (A and B), (A and C), (B and C) or (A, B and C).” The phrase “(A) B” means “(B) or (A B),” that is, A is optional.

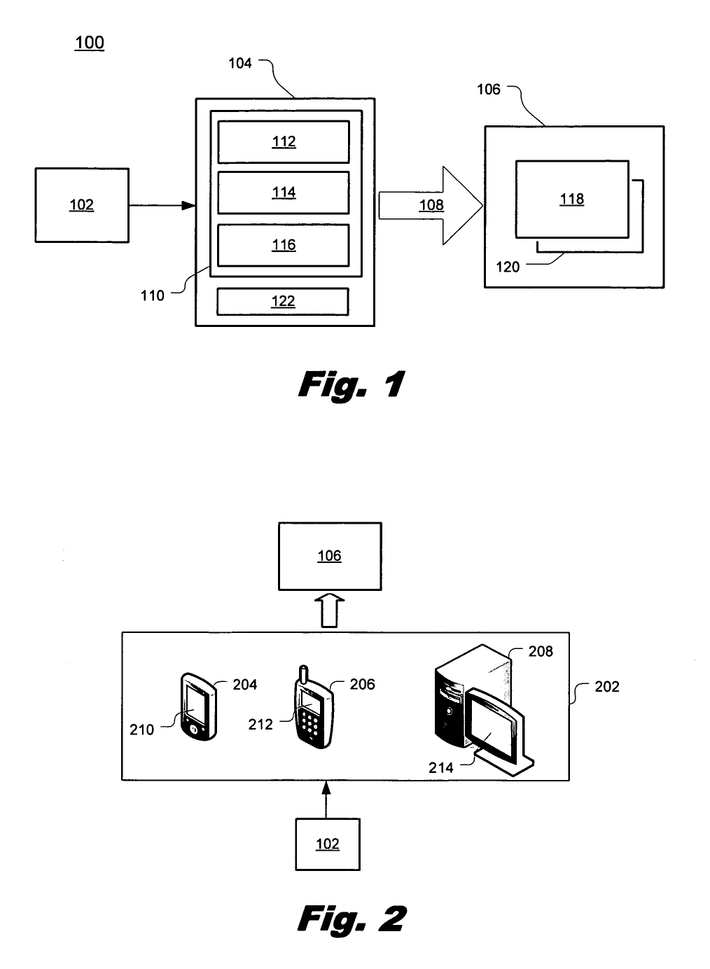

FIG. 1 illustrates a system 100 to create a document in accordance with an embodiment of the present invention. In this embodiment, an authoring application 102 may facilitate creation of a file 104 to be used as the basis of rendering a document 106 by a viewing agent 108. The file 104 may include a number of components 110 that provide complementary content and/or functionalities to the document 106. In various embodiments, the components 110 may provide the document 106 with functionalities such as, but not limited to, printing, viewing, indexing, etc. of the content rendered within the document 106.

In various embodiments, the file 104 may be a markup language document such as, but not limited to, a hypertext markup language (HTML) document, an extensible HTML (XHTML) document, etc.

In various embodiments, the authoring application 102 may be a web development tool and/or an extension of a web development tool having an extensible architecture, e.g., Macromedia Dreamweaver. In various embodiments, the rendered document 106 may be a webpage, with the viewing agent 108 being a web browser for viewing webpages in the context of the World Wide Web. However, in various embodiments, the viewing agent 108 may be any type of agent, or collection of agents, capable of rendering the document 106. In various embodiments, the viewing agent 108 may be used to view files contained or accessible to one or more digital devices. In various embodiments, the viewing agent 108 may be used for multiple uses. In various embodiments, the viewing agent 108 may be a general agent.

FIG. 2 illustrates digital devices that may be used to operate the viewing agent 108 in accordance with embodiments of the present invention. Digital devices 202 such as, but not limited to, personal digital assistant 204, cellular handset 206 and/or personal computer 208 may be capable of operating the viewing agent 108 such that the document 106 is rendered in respective viewing environments, or screens, 210, 212, and/or 214. Personal digital assistant 204, cellular handset 206, and personal computer 208 are merely provided as examples of digital devices, as a wide array of digital devices may be used in the context of various embodiments of this invention.

In various embodiments, a viewing agent may reside on a digital device for use in viewing with the digital device. In various embodiments, a viewing agent may reside on one digital device for use in viewing with another digital device (e.g., a thin client). In various embodiments, a viewing agent may reside and/or operate on multiple digital devices for viewing with one or more digital devices.

Referring again to FIG. 1 and in accordance with an embodiment of the present invention, the file 104 may include components 110 such as, an anchor component 112, an animated graphics component 114 and/or a text component 116 to facilitate rendering of the document 106. In particular, the anchor component 112, the animated graphics component 114, and/or the text component 116 may be associated with one another to facilitate rendering of animated graphics 118 of the document 106 in a manner to obfuscate the viewing of substantially simultaneously rendered text 120 of the document 106. In embodiments of this invention the animated graphics 118 may obfuscate the text 120 by making the text 120, or at least a portion of the text 120, unapparent to a viewer in at least one presentation style of the document 106. Note text 120 is shown as being offset from animated graphics 118 in FIG. 1 for purposes of clarity.

The components 110 may be divisions (DIV) of the file 104 that provide for addition and/or arrangement of content within the document 106.

In some embodiments, the anchor component 112 may be used to facilitate arrangement of the animated graphics 118 and text 120 in the document 106. For example, in one embodiment the anchor component 112 may be an absolutely positioned DIV tag that serves to create a uniform “zero” for the animated graphics component 114 and/or the text component 116. By providing an absolute position attribute for the anchor component 112, without defining the left, top, right or bottom attributes, the anchor will position itself within its context as if it had relative positioning, but the animated graphics 118 and text 120 may treat the anchor's upper left corner as the “zero.” In this way the animated graphics 118 and text 120 may be positioned anywhere in the document 106, e.g., within a table that centers horizontally beneath a 50 pixel tall masthead.

In various embodiments, the components 110 may directly provide the desired content and/or may provide links to other files having the desired content. For example, the animated graphics component 114 may include a link to an animated graphics content file, while the text component 116 may directly provide the text content. However, in other embodiments, the animated graphics component 114 may additionally/alternatively include animated graphics content and/or the text component 116 may additionally/alternatively include a link to text content. In various embodiments, the link may comprise a Uniform Resource Identifier, such as a Uniform Resource Locator. In various other embodiments, the link may involve other types of links.

The animated graphics content file may include the instructions for displaying the animated graphics 118, which may be a series of vector and/or raster graphics that when viewed, give the appearance of motion. In an embodiment, the animated graphics content file may be a Shockwave Flash (SWF) file to provide a Flash movie. In other embodiments, other formats such as, but not limited to, Graphics Interchange Format (GIF), Multiple-image Network Graphics (MNG) format, or Scalable Vector Graphics (SVG) format may be used. In various embodiments, the animated graphics component 114 may include a scripting language portion written in, for example, ActionScript, to script implementation of the animated graphics 118.

The animated graphics component 114 may provide for a window to hold the rendered animated graphics 118, e.g., the Flash movie, and may be nested within the anchor component 112 as another absolutely positioned component. The animated graphics component 114 may have top and left attributes set to zero and width and height attributes set to match like dimensions of the animated graphics content. Additionally, the z-index may be set higher than that of the text component 116 so that the animated graphics 118 are placed over the text 120 in the document 106. It may be that certain animated graphics formats, e.g., SWF, may naturally force rendered animated graphics to the top regardless of what z-index is defined. Nevertheless, placing the animated graphics 118 under the text 120 may provide a momentary display error as the components are loaded.

In various embodiments, the text component 116 may include text content for the rendering of text 120. In an embodiment, the text 120 may correspond to the content of the animated graphics 118. For example, the text 120 may comprise a text version of the animated graphics 118, an abbreviated version of such a text version, keywords describing the animated graphics 118, etc. In other embodiments, the text 120 may correspond to the animated graphics content in other ways or not at all. The nature of the text 120 may allow for certain organizational and/or presentational capabilities that may not necessarily be available to the animated graphics 118. These organizational and/or presentational capabilities may include, for example, printing, viewing by a viewing agent incapable of rendering animated graphics 118, indexing, searching, etc.

In various embodiments, in addition to text content the text 120 may also include links, headers, pictures, tables, graphics, etc. The content of the text component 116 may be static, loaded, and/or created dynamically from a database.

The text component 116 may be positioned absolutely, with the left and top attributes being set to zero and the width and the height being set slightly less than the animated graphics 118. The text component 116 may be set with a lower z-index than the animated graphics component 114 and may have an overflow attribute of “auto.” An auto overflow attribute may cause the dimensions of the text 120 to maintain the size defined and may create embedded scroll bars if the contents will not fit within the given dimensions. This may provide for a large amount of content to be provided in the text 120 without expanding beyond the boundaries of the animated graphics 118.

In various embodiments, a stylesheet language, e.g., Cascading Style Sheets (CSS), may be used to describe the presentation of the document 106. Thus, CSS may be used to facilitate the styling, e.g., colors, fonts, layout and/or other aspects of the presentation of the document 106. CSS may also allow for the document 106 to be presented differently based on certain objectives of a particular embodiment, e.g., presenting the text 120 for printing and the animated graphics 118 for viewing.

In some embodiments, it may be that the nature of the text 120, but not the animated graphics 118, is amenable to being printed. Therefore, the text component 116 may be relied upon to supplement certain printing functionalities in accordance with embodiments of the present invention. In various embodiments, a portion of the animated graphics 118 may indicate whether an unapparent accompanying text 120 is printable.

In an embodiment, printing of the text 120 may be facilitated through media-specific style sheets 122. The viewing agent 108 may be capable of reading the media-specific style sheets 122 and adjusting the presentation of the document 106 based at least in part on whether the document 106 is rendered for screen presentation or printing presentation. That is, a first style could provide for the screen presentation having the animated graphics 118 rendered in a way to obfuscate the text 120, while a second style sheet could, for example, redefine the height of the animated graphics 118 to zero and the height of the text 120 to auto. This way, when the document 106 is printed the animated graphics 118 will ‘disappear’ while the printable content will expand across the page as necessary.

In a similar manner, the document 106 may have multiple screen presentations as well. For example, in an embodiment, the text 120 may become apparent when viewed via a viewing agent not capable of rendering the animated graphics 118. A viewing agent not capable of rendering the graphic may lack such capability due to a number of reasons, including not having the necessary functionality, having such a capability but having the functionality not enabled, and so forth. In various embodiments, a viewing agent may need to work in conjunction with third-party software in order to render the graphic.

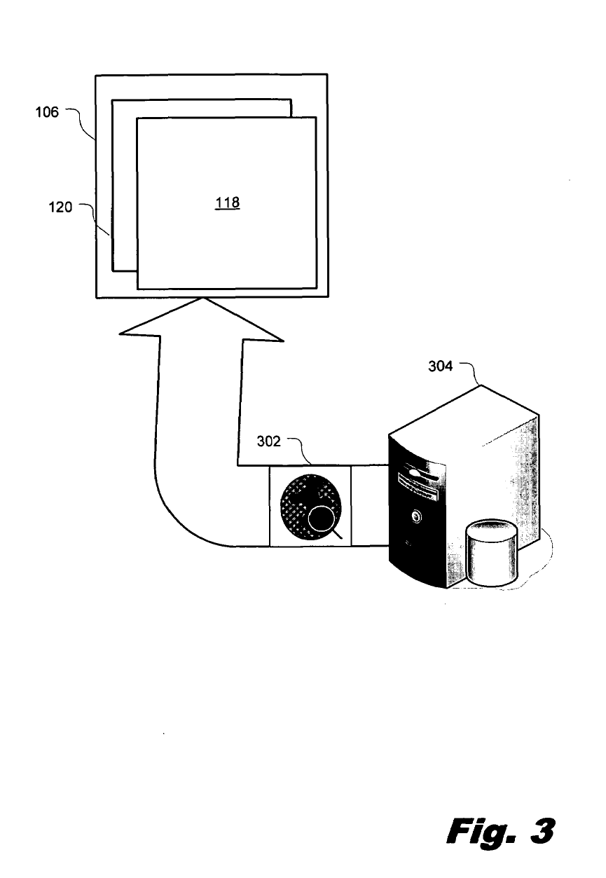

In various embodiments, the text component 116 may be structured in a way to facilitate indexing and searching of the content by a search engine. FIG. 3 illustrates some aspects of search engine indexing and/or searching in accordance with an embodiment of the present invention. In various embodiments, a search engine 302 may reside on host 304, or on multiple hosts. In various embodiments, search engine 302 may not reside on a host or multiple hosts. To facilitate search engine 302 in indexing the content of the document 106, the text component 116 may be discernable by search engine 302. In various embodiments, search engine 302 may comprise a search engine, a search agent, and so forth. The term “search engine” as used herein, may include any type of search engine, including, but not limited to, a web search engine, a personal search engine, an enterprise search engine, a mobile search engine, and so forth.

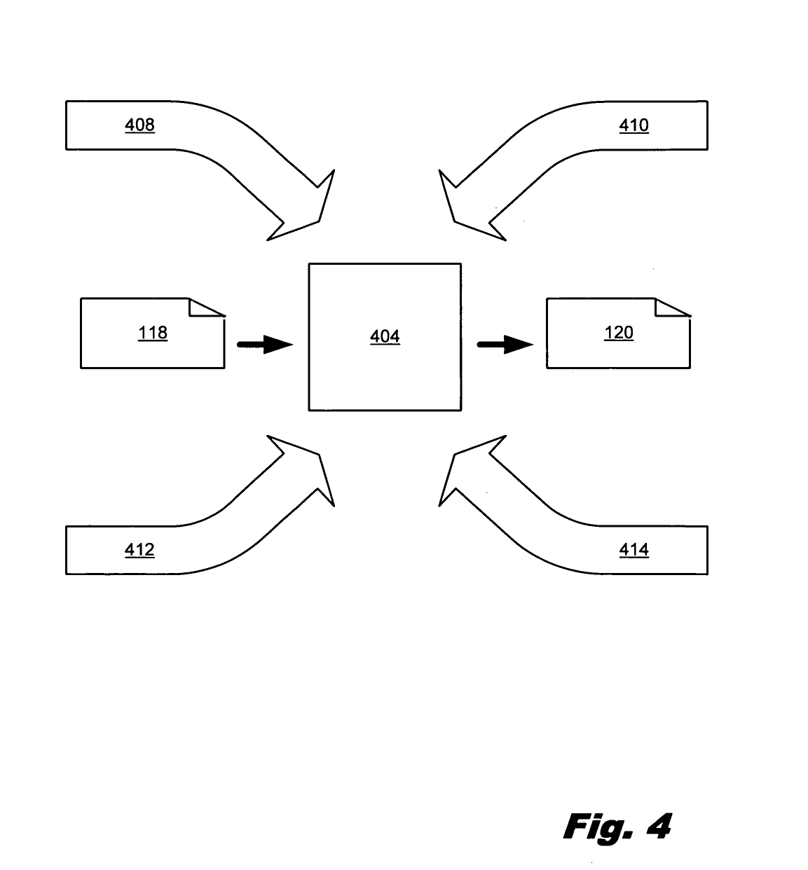

While in some embodiments, a text description of animated graphics is developed manually, e.g., by a programmer, in other embodiments, the descriptive content of the text 120 may be automatically developed based upon the animated graphics 118. FIG. 4 illustrates some aspects of a graphics-to-description conversion method, in accordance with various embodiments of this invention. While certain blocks are illustrated in FIG. 4, other blocks may supplement or supplant the blocks shown, in the context of various embodiments. FIG. 4 includes animated graphics 118, converter 404, text 120, processing 408, artificial intelligence 410, fuzzy logic 412, and converting techniques 414. In various embodiments, a graphics-to-description converter may take other forms, and/or may be represented differently. In various embodiments, a search engine may facilitate the creation of text 120 based on the animated graphics 118, and then associate the text 120 with the animated graphics 118. In various embodiments, a search engine may create text 120 based on animated graphics 118, and then associate the text 120 with the animated graphics 118. In various embodiments, text 120 and its association to the animated graphics 118 may be internal to a database maintained by a search engine.

In various embodiments, an automatic method for indexing the animated graphics 118 by a search engine may include a number of operations, including rendering the animated graphics 118, performing character recognition on the rendered graphics 118 to produce descriptive text 120, and associating the text 120 with the graphics 118 to facilitate indexing by the search engine. Performing character recognition may take a number of forms, and may include various processing operations 408, use of artificial intelligence 410 and/or fuzzy logic 412, and various converting techniques 414. Converter 404 may convert animated graphics 118 to text 120 in a wide range of ways, using varying amounts of sophistication. For example, one way to perform the conversion may include analyzing objects of the same color in an image as a discrete set of objects. Such objects may be compared against a database of alphanumeric characters to determine if the objects may represent alphanumeric characters. Identification of words may then follow identification of groupings of alphanumeric characters. These words may form the description to be associated with the animated graphics for indexing purposes. In some embodiments, further analysis may be performed on any identified, or likely identified words, to analyze potential groupings and/or meanings of the words. In various embodiments, multilingual determinations may be involved.

In various embodiments, converter 404 may operate at another state of sophistication, including, for example, analyzing animated graphics for machine-cognizable shapes (e.g., apparel for perusal and purchase). Additional input data to such a conversion may include words potentially identified in the graphic.

In various embodiments, associating text 120 with animated graphics 118 may include creation/modification of underlying text component 116 and/or underlying animated graphics component 114 such that a rendering of the animated graphics 118 obfuscates the text 120. The sophistication of converter 404 may vary widely, depending on the implementation and the information available to make the conversion.

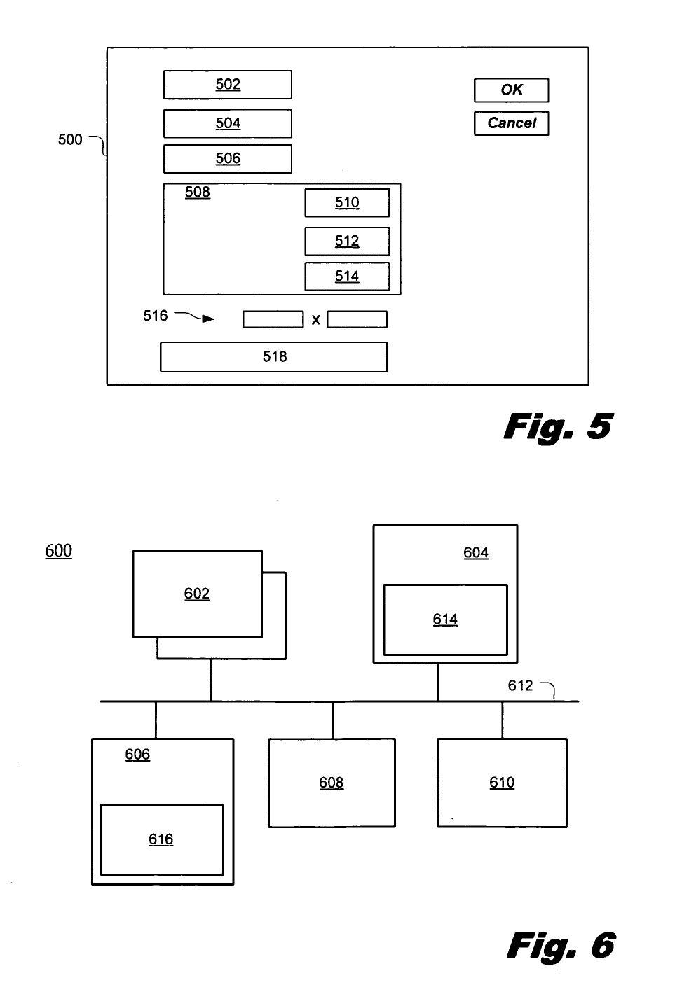

FIG. 5 illustrates a user-interface 500 of the authoring application 102 in accordance with an embodiment of the present invention. In this embodiment, the user interface 500 may provide fields for a file model 502 to determine the type of file to create, e.g., HTML, and paths to various content, e.g., text 504, a style sheet 506, and/or animated graphics 508. In some embodiments, the animated graphics content 508 may include fields for content sources, e.g., a source file 510 (e.g., a file with a fla extension to allow for editing), a movie 512 (e.g., a rendered movie file with a .swf extension), and/or scripts 514. The user interface 500 may also provide fields 516 for determining dimensions of animated graphics window.

In various embodiments, the authoring application 102 may have a variety of page fields 518 to facilitate creation of a site, e.g., a website, having a plurality of related documents, e.g., pages, similar to document 106. The authoring application 102 may facilitate creation of a file, similar to file 104, for each page of the site, e.g., documents 106.

In many instances, creating additional files may simply require copying the file and updating any component content within the file to reflect desired content of particular document. Different animated graphics content files may be used for different pages within the website. Likewise, textual content related to each of the animated graphics content may also be incorporated into the different pages. The text content of a file may contain links to text of other files, thereby reflecting an association between the animated graphics of the pages. In this manner, the text may provide a hook to facilitate navigation among and through the animated graphics content contained within the site. This could also facilitate search engine indexing and/or searching.

In various embodiments, a search engine may pick up and display these links/text (on a search engine result page, etc.). In some embodiments, these further links may also be separately used outside of the context of a search engine. For example, when the animated graphics comprise a Flash movie, the invocation of these links may direct a browser to an associated frame of the Flash movie (by, e.g., the link passing a variable representing the desired frame to the Flash movie). For a website that contains a single Flash movie, such a link may direct a user to a frame within the movie. For a website that contains multiple Flash movies, such a link may direct a user to the relevant Flash movie.

In various embodiments, the page fields 518 may facilitate provision of page titles, metadata and/or paths to the files corresponding to each of the pages of the site. The titles and/or metadata, e.g., “home,” “contact us,” “about us,” etc., may better represent each page's content.

FIG. 6 illustrates an example computer system suitable for use in implementing authoring application 102, in accordance with various embodiments of this invention. As shown, computer system 600 may include one or more processors 602 and may include system memory 604. Additionally, computer system 600 may include mass storage 606 in the form of one or more devices (such as diskette, hard drive, compact disk (CD), flash memory, and so forth), input/output devices 608 (such as keyboard, cursor control and so forth) and communication interfaces 610 (such as network interface cards, modems and so forth). The elements may be coupled to each other via system bus 612, which may represent one or more buses. In the case where system bus 612 represents multiple buses, the multiple buses may be bridged by one or more bus bridges (not shown).

These elements each perform their conventional functions known in the art. In various embodiments, communication interfaces 610 may facilitate coupling of computer system 600 to a network, or an interconnection of networks, such as the Internet. System memory 604 and mass storage 606 may be employed to store a working copy and a permanent copy of the programming instructions implementing various aspects of the one or more earlier described embodiments of the present invention. In various embodiments, instructions 614 may comprise such a working copy, and instructions 616 may comprise such a permanent copy. In various embodiments, nonvolatile memory may serve to hold one copy of any instructions, with the one copy serving the functions of both a working copy and a permanent copy of the instructions.

The permanent copy of the programming instructions may be loaded into mass storage 606 in the factory or in the field, through a distribution medium (not shown), or through communication interfaces 610 from, for example, a distribution server (not shown). In alternate embodiments, part or all of the one or more modules may be implemented in hardware, for example, using one or more Application Specific Integrated Circuits (ASICs) instead.

While the present invention has been described in terms of the foregoing embodiments, those skilled in the art will recognize that the invention is not limited to the embodiments described. Other embodiments may be practiced with modification and alteration within the spirit and scope of the appended claims. Accordingly, the description is to be regarded as illustrative instead of restrictive.

What is claimed is

1. A method of creating a file comprising:
creating a text component of a file adapted to facilitate rendering of text by a viewing agent in a viewing environment; and
creating an animated graphics component of the file adapted to facilitate rendering of animated graphics by the viewing agent in the viewing environment in a manner to obfuscate viewing of the text in the viewing environment.

2. The method of claim 1, further comprising:
creating an anchor component to facilitate rendering of the text component and animated graphics component in said manner.

3. The method of claim 2, further comprising:
referencing positioning of animated graphics and text within the viewing environment based at least in part on the anchor component.

4. The method of claim 1, wherein said creating of an animated graphics component of the file to facilitate rendering of animated graphics further comprises:
invoking content providing the animated graphics to be rendered.

5. The method of claim 4, wherein the content comprises a Shockwave Flash file.

6. The method of claim 1, further comprising:
rendering the file as a webpage including the animated graphics and text.

7. The method of claim 1, wherein said creating of a text component of the file further comprises:
providing the text in a manner discernable by a search engine to facilitate indexing of the text.

8. The method of claim 7, wherein said indexing of the text is for at least Internet search purposes.

9. The method of claim 7, wherein said indexing of the text is for at least digital device search purposes.

10. The method of claim 1, wherein said creating of a text component further comprises:
providing text to describe the animated graphics.

11. The method of claim 1, wherein the file comprises a markup language document.

12. The method of claim 1, wherein said creating of the animated graphics component and creating of the text component further comprises:
describing a style of the animated graphics component and a style of the text component using a stylesheet computer language to facilitate rendering of the animated graphics in a manner to obfuscate viewing of the text in the viewing environment.

13. The method of claim 12, wherein stylesheet computer language comprises a cascading stylesheet language.

14. A machine accessible medium having associated instructions, which, when accessed, results in a machine performing:
providing for receipt of text component content;
creating a text component, based at least in part on the text component content, adapted to be rendered by a viewing agent to provide text within a viewing environment;
providing for receipt of animated graphics component content; and
creating an animated graphics component, based at least in part on the animated graphics component content, to facilitate rendering of animated graphics by the viewing agent in the viewing environment in a manner that obfuscates viewing of the text in the viewing environment.

15. The machine accessible medium of claim 14, wherein the associated instructions, which, when accessed, results in a machine:
creating an anchor component to facilitate rendering of the text component and animated graphics component in said manner.

16. The machine accessible medium of claim 15, wherein the associated instructions, which, when accessed, results in a machine:
causing, upon rendering, the animated graphics and text to be positioned within the document based at least in part on the anchor component.

17. The machine accessible medium of claim 15, wherein the associated instructions, which, when accessed, results in a machine:
providing for receipt of a Shockwave Flash file as the animated graphics component content.

18. A document comprising:
text adapted to be rendered by a viewing agent in a viewing environment; and
animated graphics adapted to be rendered by the viewing agent in the viewing environment in a manner to obfuscate viewing of the text in the viewing environment.

19. The document of claim 18, wherein the document comprises a webpage.

20. The document of claim 18, wherein the animated graphics comprises a Flash movie.

21. The document of claim 18, wherein the text is discernible by a search engine.
